(19) United States
(12) Patent Application Publication
(10) Pub. No.: US 2009/0262076 A1
(43) Pub. Date: Oct. 22, 2009

(54) INPUT DEVICE FOR WEB ENABLED DEVICES

(76) Inventors: Jennifer Brugger, Newbury Park, CA (US); Richard Mahr, Los Angeles, CA (US)

Correspondence Address: THE HECKER LAW GROUP, Suite 2300, 1925 Century Park East, Los Angeles, CA, 90067, US

(21) Appl. No.: 12/105,116

(22) Filed: Apr. 17, 2008

(51) Int. Cl. G06F 3/02

(52) U.S. Cl. 345/168

(57) ABSTRACT

In one or more embodiments, one or more keys are provided on the keyboard or keypad of a computer, cell phone, PDA, or other web enabled device that, when pressed, automatically enters a character stream for a URL or email address component. In one or more embodiments, a single key can be used to enter multiple character strings. For example, in one embodiment, a key is provided that normally enters “www.” when pressed, but enters “.com” when a “shift” key is pressed concurrently with the key. In one or more embodiments, additional character strings representing other portion s are entered by pressing one or more auxiliary keys, such as the “alt”, “ctrl” or “fn” keys, concurrently with the key.

### FIELD OF THE INVENTION

The invention relates to input devices such as keyboards and keypads used with computers, cell phones, and any other devices that are capable of connecting to the internet.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

Computers, cell phones, personal digital assistants (“PDA's”), digital music players, video game consoles, and other electronic devices are used to access the internet for web browsing, sending and receiving email, listening to or watching streaming video and music, and for other and ever expanding purposes. Content on the internet (e.g. a webpage, video or music streams, news feeds, etc) is provided by servers that typically have been given a website address, also sometimes referred to as a domain name or “uniform resource locator” or “URL.” An example of a website address is “www.yahoo.com.” Website addresses are most commonly of the form “www.sld.tld”, where “www” stands for the “world wide web,” “sld” is the second level domain, and “tld” is the top level domain. For example, in the address “www.yahoo.com,” the second level domain is “yahoo”, and the top level domain is “com.” “Com” is by far the most prevalent top level domain. Others include “net”, “gov”, “org”, and country specific top level domains such as “us”, “uk”, “de”, and “fr.”

Email addresses are typically of the form “name@sld.tld”, where “name” is a mail account name for an email account at the mail server for the “sld.tld” web address. An example of a typical email address is “info@yahoo.com.”

Browsing to a particular web page often involves typing the web address for the webpage into the address field of a web browser. As indicated above, doing so typically involves typing first “www.”, then the particular name (sld) for the web page sought, followed by “.com” (or “.net”, “.org”, or other “.tld”). In some cases, a full URL is required, which adds a protocol identifier before the web address and may or may not include “www.”, such as, for example: “http://samplesite.com” or “http://www.yahoo.com”. Similarly, entering someone's email address in an email program typically involves first typing the person's particular email account name, then the character “@” followed by the sld, and finally “.com” (or “.net”, “.org”, or other “.tld”). Web browsing thus involves the repetitive typing of “www.” and “.com” (or other “.tld”), while sending emails involves repetitive typing of “.com” (or other “.tld”).

### SUMMARY OF THE INVENTION

The present invention alleviates the repetitive typing of standard portions of URL's and email addresses (such as, for example, “http://”, “www.” and “.com”) by providing one or more special purpose keys that can be used to enter each of a variety of standard components of URL or email address with a single keystroke. The keys of the invention are sometimes referred to as “iClick”™ keys herein. In one or more embodiments, one or more keys are provided on the keyboard or keypad of a computer, cell phone, PDA, or other web enabled device that, when pressed, automatically enters a character string for a URL or email address component. In one or more embodiments, a single key can be used to enter multiple character strings. For example, in one embodiment, a key is provided that normally enters “www.” when pressed, but enters “.com” when a “shift” key is pressed concurrently with the key. In one or more embodiments, additional character strings representing other portions of a URL are entered by pressing one or more auxiliary keys, such as the “alt”, “ctrl” or “fn” keys, concurrently with the iClick™ key. In one or more embodiments, two iClick™ keys are provided, the first of which enters components typically found in the left portion of a URL (e.g. “http://”, “www.”, “ftp://”), and the second of which enters components typically found in the right portion of a URL (e.g. “.com”, “.net”, “.org”). In one or more embodiments, the components entered by an iClick™ key include country-specific components, such as, for example “.co.uk”.

The iClick™ keys of the present invention may be additional to the conventional keys of a keyboard or keypad, or may replace keys that have other functions. For example, keyboards often have two “alt” and “ctrl” keys. In one or more embodiments, one or more iClick™ keys are located in a keyboard at a location formerly occupied by an “alt” or “ctl” key. In one or more embodiments, the keys of the present invention are included in a mouse or other input device.

### BRIEF DESCRIPTION OF THE DRAWINGS

FIG. 1 shows an example of a keyboard of the prior art.

FIG. 2 shows an example an ergonomic keyboard of the prior art.

FIG. 3 shows an example of an embodiment of a keyboard comprising keys of the present invention.

FIG. 4 shows an example of an embodiment of a keyboard comprising keys of the present invention.

FIG. 5 shows an example of an embodiment of an ergonomic keyboard comprising keys of the present invention.

FIG. 6 shows an example of an embodiment of a mouse comprising keys of the present invention.

### DETAILED DESCRIPTION OF THE INVENTION

The invention comprises one or more keys that automatically enter one or more character strings that represent a standard component of a URL or email address (such as, for example, “www.”, “.com”, “.net”, “http://”, or “.co.uk”) when pressed, alone or in combination with one or more other keyboard keys. The keys may be located on a keyboard, keypad, mouse or other input device for any internet capable apparatus or device. In the following description, numerous specific details are set forth to provide a thorough description of the present invention. It will be apparent, however, to one skilled in the art, that the invention may be practiced without these specific details. In other instances, well known features have not been described in detail so as not to obscure the invention.

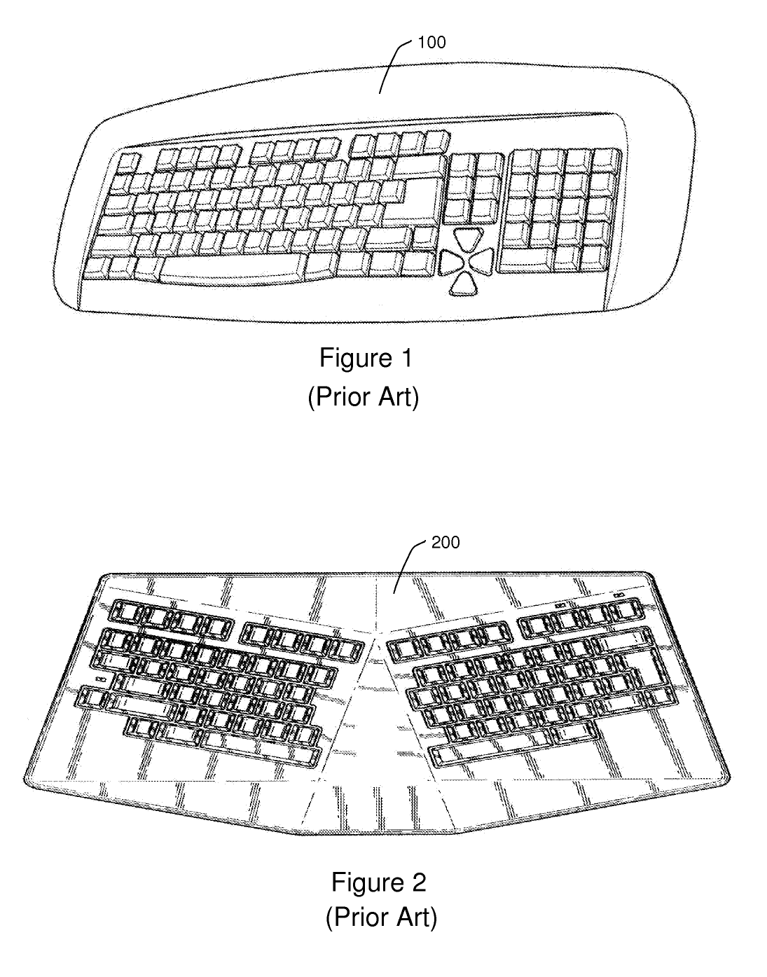

FIGS. 1-2 show examples of typical computer keyboards of the prior art. Such keyboards usually use the well-known “QWERTY” key layout. FIG. 1 shows a computer keyboard 100 having a traditional form. FIG. 2 shows a computer keyboard 200 having an ergonomic form.

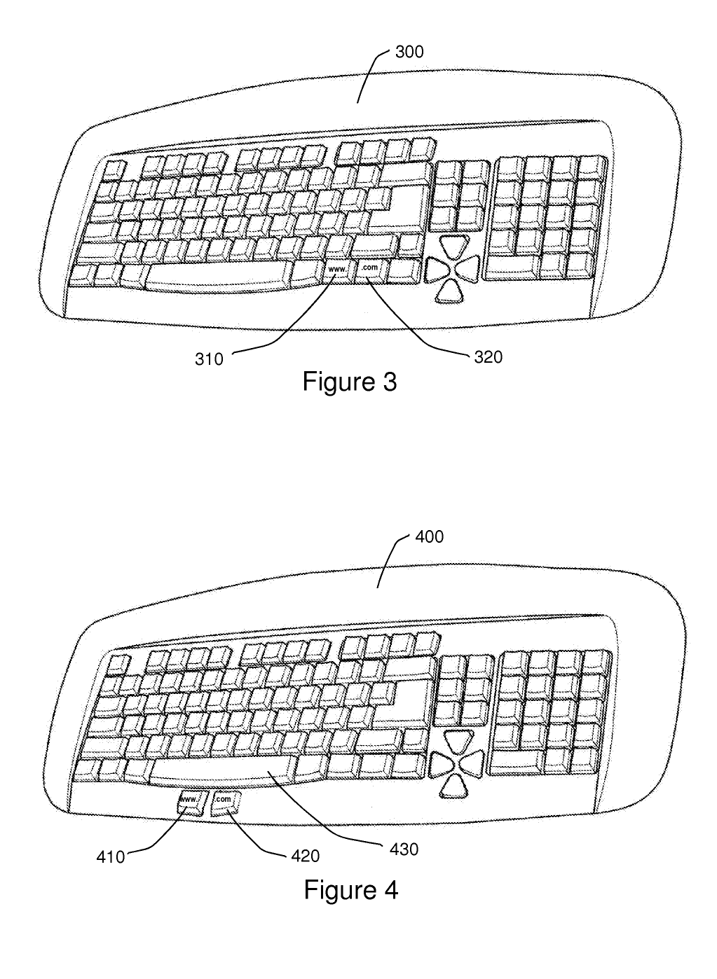

FIG. 3 shows an embodiment of a keyboard 300 similar to keyboard 100 of FIG. 1 in which two of the keys 310 and 320 have been replaced with the iClick™ keys of the present invention. In FIG. 3, key 310 has been imprinted with the characters “www.”, while key 320 has been imprinted with the characters “.com”. In the embodiment of FIG. 3, “www.” is the default character string that is entered when key 310 is pressed alone (without the simultaneous pressing of any other key). “com.” is the default character string that is entered when key 320 is pressed alone. In other embodiments, these default strings may constitute other URL components. For example, for a keyboard intended to be sold in the United Kingdom, the default character string for key 320 can be “.co.uk”.

In one or more embodiments, pressing either of keys 310 or 320 in combination with one or more auxiliary keys (such as, for example, an alt, ctrl, shift or fn key) may cause alternate character strings other than the default character strings to be entered. For example, in one or more embodiments, pressing key 310 in combination with the shift key causes the character string “http://” to be entered, instead of the default string “www.”. Similarly, in one or more embodiments, pressing key 320 in combination with the shift key causes the character string “.net” to be entered, instead of the default string “.com”. Tables 1-4 provide examples of alternative character strings that are entered in one or more embodiments of the invention when iClick™ keys of the present invention are pressed in combination with other keys, such as the shift, alt, control, and function keys. In table 1, URL components that typically form the beginning portion of a URL are associated with the first key (such as key 310 of FIG. 3), and URL components that typically form the ending portion of a URL are associated with the second key (such as key 320 of FIG. 3). It will be apparent to those skilled in the art that other variations of character strings representing portions of URL's may be associated with similar and/or other combinations of keys 310 and 320 with other keys.

TABLE 1

| Combination | First Key | Second Key |
|---|---|---|
| Alone | www. | .com |
| w/Shift | http:// | .net |
| w/Alt | https:// | .org |
| w/Ctrl | ftp:// | .edu |
| w/Fn | none | .gov |

In one or more embodiments, a single iClick™ key of the invention (e.g. key 310) is provided. In those embodiments, the single iClick™ key provides both beginning and ending URL components, depending on the key combination pressed. Table 2 below shows the character strings that are entered in one or more single key embodiments of the invention. In will be understood by those of skill in the art that a large variety of pairings between key combinations and URL components are possible.

TABLE 2

| Combination | Single Key |
|---|---|
| Alone | www. |
| w/Shift | .com |
| w/Alt | .net |
| w/Ctrl | .org |
| w/Fn | http:// |

In other embodiments, any number of iClick™ keys may be provided, each of which may be configured to enter one or more character strings representing parts of a URL. Tables 3 and 4 below show character strings that are entered in example embodiments that include 3 and 4 iClick™ keys, respectively.

TABLE 3

| Combination | First Key | Second Key | Third Key |
|---|---|---|---|
| Alone | www. | .com | .tv |
| w/Shift | http:// | .net | .biz |
| w/Alt | https:// | .org | .name |
| w/Ctrl | ftp:// | .edu | .us |
| w/Fn | none | .gov | .md |

TABLE 4

| Combination | First Key | Second Key | Third Key | Fourth Key |
|---|---|---|---|---|
| Alone | www. | .com | .tv | .com.cn |
| w/Shift | http:// | .net | .biz | .net.cn |
| w/Alt | https:// | .org | .name | .org.cn |
| w/Ctrl | ftp:// | .edu | .us | .com.tw |
| w/Fn | none | .gov | .md | .org.tw |

In one or more embodiments, the character strings entered by activating an iClick™ key of the invention may include non-English characters, such as for example, Arabic, Chinese, Cyrillic, Sanskrit, or other characters as may be used in non-English character URL's.

The iClick™ key(s) of the present invention can be incorporated in a prior art keyboard by replacing other keys normally present (as in the embodiment of FIG. 3). In one or more embodiments, replacing a key comprises altering the function of a key via software programming and altering the appearance of the key to indicate its new functions. In one or more embodiments, the appearance is altered by providing the key with an overlay or a cap, or by removing the key and replacing it with a new key that included appropriate marking. Alternatively, one or more iClick™ keys of the invention may be added to the keys normally present. The key(s) may be placed in any portion of the keyboard, keypad, or other input device.

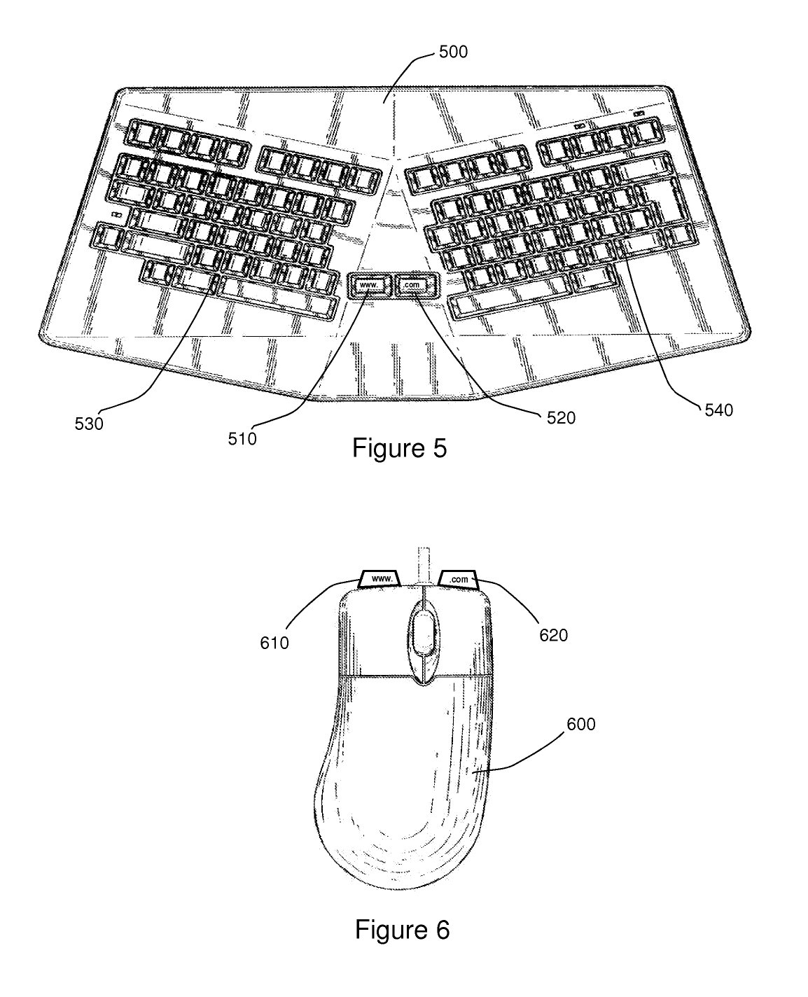

FIGS. 4 and 5 show alternative placements for the keys of the present invention. In FIG. 4, iClick™ keys 410 and 420 are placed below spacebar 430 of keyboard 400. In FIG. 5, iClick™ keys 510 and 520 are placed in between left and right hand portions 530 and 540 of ergonomic keyboard 500.

The iClick™ key(s) of the invention need not be located on a keyboard, but can be included in any user input device. For example, FIG. 6 shows an embodiment in which iClick™ keys 610 and 620 are incorporated in a mouse 600. In the embodiment of FIG. 6, iClick™ keys 610 and 620 are located along the front portion of mouse 600. However, other locations may be used.

To identify the keys of a keyboard or keypad as an iClick™ key of the invention, the keys may be imprinted with one or more of the character strings that are entered upon activation of the character, such as, for example, “www.” or “.com”, as on keys 310 and 320 of FIG. 3. In one or more embodiments, in addition to or as an alternative to imprinting, the key surface may have physical markings molded therein, such as, for example, braille markings. In one or more embodiments, the keys may comprise electronic display elements that provide an indication as to the character string that will result by activating a key. In one or more embodiments, the display elements comprise a OLED display of the kind used in the Optimus Maximus Keyboard from Art. Lebedev Studio.

Thus novel keys for input devices including keyboards, keypads, and mice been presented. Although the present invention has been described with respect to particular example embodiments, it will be understood by those of skill in the art that the invention is not limited to those particular embodiments, but includes alternative embodiments that will be evident to those skilled in the art. For example, although the keys of the invention have been described with respect to input devices for computers, the keys of the invention my be used for any web enabled device, including, without limitation, cell phones, web enabled organizers, music and media players, video game consoles, and web enabled appliances. Further, although embodiments have been described with respect to physical keys, the keys of the invention need not be physically separate items but may be implemented in the form of virtual keys on a touchscreen.

1. An input device for a web enabled device comprising:
a first key that enters a first character string representing a first standard portion of a URL upon activation.

2. The input device of claim 1 wherein said first key enters a second character string representing a second standard portion of a URL upon activation in combination with a first auxiliary key.

3. The input device of claim 2 wherein said first key enters a third character string representing a third standard portion of a URL upon activation in combination with a second auxiliary key.

4. The input device of claim 3 wherein said first key enters a fourth character string representing a fourth standard portion of a URL upon activation in combination with a third auxiliary key.

5. The input device of claim 4 wherein said first key enters a fifth character string representing a fifth standard portion of a URL upon activation in combination with a fourth auxiliary key.

6. The input device of claim 1 further comprising a second key that enters a second character string representing a second standard portion of a URL upon activation.

7. The input device of claim 6 wherein said second key enters a third character string representing a third standard portion of a URL upon activation in combination with a first auxiliary key.

8. The input device of claim 2 further comprising a second key that enters a third character string representing a third standard portion of a URL upon activation.

9. The input device of claim 8 wherein said second key enters a fourth character string representing a fourth standard portion of a URL upon activation in combination with a first auxiliary key.

10. The input device of claim 1 wherein said input device comprises a keyboard.

11. The input device of claim 1 wherein said input device comprises a keypad.

12. The input device of claim 1 wherein said input device comprises a mouse.

13. The input device of claim 1 wherein said web enabled device comprises a computer.

14. The input device of claim 1 wherein said web enabled device comprises a telephone.

15. The input device of claim 1 wherein said web enabled device comprises a personal digital assistant.

16. The input device of claim 1 wherein said web enabled device comprises a media player.

17. The input device of claim 1 wherein said web enabled device comprises a video game console.

18. The input device of claim 1 wherein said first standard portion of a URL is “www.”.

19. The input device of claim 2 wherein the second standard portion of a URL is “.com”.

20. The input device of claim 6 wherein the second standard portion of a URL is “.com”.
